(19) United States
(12) Patent Application Publication
(10) Pub. No.: US 2016/0086065 A1
(43) Pub. Date: Mar. 24, 2016

(54) IMAGE FORMING APPARATUS AND IMAGE PROCESSING DEVICE

(71) Applicant: Fuji Xerox Co., Ltd., Tokyo (JP)

(72) Inventors: Hidetoshi KAWASHIMA, Kanagawa (JP); Masayuki KANEDA, Kanagawa (JP); Toru MISAIZU, Kanagawa (JP); Kenji HARA, Kanagawa (JP)

(21) Appl. No.: 14/679,340

(22) Filed: Apr. 6, 2015

(30) Foreign Application Priority Data
Sep. 22, 2014 (JP) 2014-193036

(51) Int. Cl. G06K 15/02; G06F 3/12

(52) U.S. Cl. CPC G06K 15/1843; G06K 15/1822; G06F 3/1208; G06F 3/1243

(57) ABSTRACT

An image forming apparatus includes an image forming section and an image processing section. The image forming section forms an image on a recording medium. When image information for forming the image with the image forming section includes information of a barcode image and one of a resolution of the image forming section and a resolution of the image information is not an integer multiple of the other, the image processing section regards a resolution of a part of the image information used for the barcode image as a different resolution so that one of the resolution of the part of the image information used for the barcode image and the resolution of the image forming section is an integer multiple of the other to perform rasterization.

### CROSS-REFERENCE TO RELATED APPLICATIONS

This application is based on and claims priority under 35 USC 119 from Japanese Patent Application No. 2014-193036 filed Sep. 22, 2014.

### BACKGROUND

(i) Technical Field

The present invention relates to an image forming apparatus and an image processing device.

(ii) Related Art

For example, in image forming apparatuses such as copiers and printers that use an electrophotographic method or an ink-jet method, an image may be formed by an image forming section after a variety of types of image processing have been performed on image information having been input.

### SUMMARY

According to an aspect of the present invention, an image forming apparatus includes an image forming section and an image processing section. The image forming section forms an image on a recording medium. When image information for forming the image with the image forming section includes information of a barcode image and one of a resolution of the image forming section and a resolution of the image information is not an integer multiple of the other, the image processing section regards a resolution of a part of the image information used for the barcode image as a different resolution so that one of the resolution of the part of the image information used for the barcode image and the resolution of the image forming section is an integer multiple of the other to perform rasterization.

### BRIEF DESCRIPTION OF THE DRAWINGS

Exemplary embodiment of the present invention will be described in detail based on the following figures, wherein:

FIG. 1 illustrates an outline of an image forming apparatus according to an exemplary embodiment;

FIG. 2 is a block diagram illustrating a signal processing system of a controller of the image forming apparatus;

FIG. 3 illustrates an example of a barcode image;

FIGS. 4A and 4B illustrate a guideline in accordance with GS1-128 regarding the barcode image as illustrated in FIG. 3;

FIGS. 5A to 5F illustrate a problem occurring when the numbers of dots that are the same before the resolutions are converted become different from one another after a resolution has been converted;

FIG. 6 is a block diagram illustrating a resolution processing unit according to the present exemplary embodiment;

FIG. 7 is a flowchart illustrating operations of the resolution processing unit;

FIG. 8 is a flowchart illustrating a procedure in which an image type determining part determines whether or not image data includes barcode image information;

FIG. 9 illustrates a method of determining whether a pixel of interest is an edge pixel or a non-edge pixel; and

FIG. 10 is a table illustrating examples of two types of thresholds.

### DETAILED DESCRIPTION

### Description of an Overall Configuration of an Image Forming Apparatus

An exemplary embodiment of the present invention will be described in detail below with reference to the accompanying drawings.

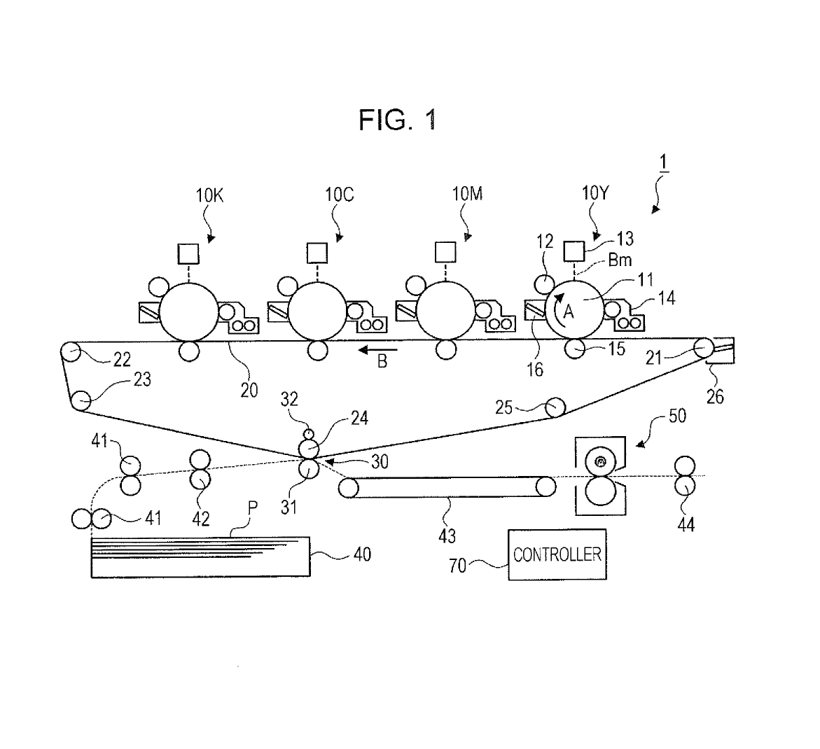

FIG. 1 illustrates an outline of an image forming apparatus 1 according to an exemplary embodiment.

This image forming apparatus 1 includes, for example, plural (four in the present exemplary embodiment) image forming units 10 (specifically, 10Y (yellow), 10M (magenta), 10C (cyan), and 10K (black)) with which toner images of color components are formed by an electrophotographic method. The image forming apparatus 1 also includes an intermediate transfer belt 20 that holds the toner images of the color components formed by the image forming units 10 and sequentially transferred (first transfer) thereto. Furthermore, the image forming apparatus 1 includes a second transfer device 30 that collectively transfers (second transfer) the toner images having been transferred onto the intermediate transfer belt 20 onto a sheet of paper P (recording material, recording medium). Furthermore, the image forming apparatus 1 includes a fixing device 50 and controller 70. The fixing device 50 fixes the toner images having undergone the second transfer onto the sheet P. The controller 70 controls mechanisms of the image forming apparatus 1.

In the present exemplary embodiment, an image forming section that forms images on the sheet P includes the image forming units 10, the intermediate transfer belt 20, the second transfer device 30, and the fixing device 50.

The configurations of the image forming units 10 (10Y, 10M, 10C, and 10K) are the same except for the colors of the toner used in the image forming units 10. Thus, the yellow image forming unit 10Y is used as an example in the following description. The yellow image forming unit 10Y includes a photosensitive drum 11 having a photosensitive layer (not illustrated). The photosensitive drum 11 is rotatable in an arrow A direction and holds an image. A charging roller 12, an exposure unit 13, a developing unit 14, a first transfer roller 15, and a drum cleaner 16 are disposed around the photosensitive drum 11.

Out of these, the charging roller 12 is a rotating body in contact with the photosensitive drum 11. The charging roller 12 is connected to a charging power source (not illustrated). The charging power source supplies a positive-polarity or negative-polarity direct-current charging bias, on which an alternating-current charging bias of a predetermined frequency is superimposed, to the charging roller 12.

The exposure unit 13 writes with a laser beam Bm an electrostatic latent image on the photosensitive drum 11 having been charged by the charging roller 12. The developing unit 14, which contains the toner of the corresponding color component (the yellow image forming unit 10Y contains yellow toner), develops the electrostatic latent image on the photosensitive drum 11 with the toner. The first transfer roller 15 transfers the toner image formed on the photosensitive drum 11 onto the intermediate transfer belt 20 through first transfer. The drum cleaner 16 removes residues (such as toner) from the photosensitive drum 11 after the first transfer has been performed.

The intermediate transfer belt 20 is rotatably stretched over and supported by plural (five in the present exemplary embodiment) support rollers. Out of these support rollers, a drive roller 21 stretches the intermediate transfer belt 20 and drives the intermediate transfer belt 20, so that the intermediate transfer belt 20 is rotated in an arrow B direction. Stretch rollers 22 and 25 stretch the intermediate transfer belt 20 and are rotated by the intermediate transfer belt 20, which is driven by the drive roller 21. A correction roller 23 stretches the intermediate transfer belt 20 and functions as a steering roller (disposed so as to be tiltable about one end portion in the axial direction) that regulates deviation of the intermediate transfer belt 20 in a direction perpendicular to a transport direction of the intermediate transfer belt 20. Furthermore, a backup roller 24 stretches the intermediate transfer belt 20 and functions as a component of the second transfer device 30.

Also, a belt cleaner 26 is disposed at a position facing the drive roller 21 with the intermediate transfer belt 20 interposed therebetween. The belt cleaner 26 removes residues (such as toner) from the intermediate transfer belt 20 after second transfer has been performed.

The second transfer device 30 includes a second transfer roller 31 and the backup roller 24. The second transfer roller 31 is disposed on a toner image holding surface side of the intermediate transfer belt 20 and in pressure contact with the intermediate transfer belt 20. The backup roller 24 is disposed on a rear surface side of the intermediate transfer belt 20 and serves as a counter electrode of the second transfer roller 31. This backup roller 24 is in contact with a power supply roller 32. The power supply roller 32 applies a second transfer bias of the same polarity as a toner charging polarity to the backup roller 24. The second transfer roller 31 is grounded.

A sheet transport system includes a sheet tray 40, transport rollers 41, a registration roller 42, a transport belt 43, and an output roller 44. The sheet transport system transports the sheet P loaded in the sheet tray 40 with the transport rollers 41, temporarily stops the sheet P with the registration roller 42, and then feeds the sheet P to a second transfer position of the second transfer device 30 at a predetermined timing. Furthermore, the sheet transport system transports the sheet P having undergone second transfer to the fixing device 50 through the transport belt 43 and outputs the sheet P having exited the fixing device 50 to the outside of the image forming apparatus 1 with the output roller 44.

Next, a basic image forming process of the image forming apparatus 1 is described. Now, a predetermined image forming process is performed upon performing a turning on operation with a start switch (not illustrated). Specifically, in the case where the image forming apparatus 1 is configured as, for example, a printer, digital image signals input from the outside of the image forming apparatus 1, for example, from a personal computer (PC) are temporarily stored in memory. Toner images of the colors are formed in accordance with the digital image signals of the four colors (Y, M, C, and K colors) stored in the memory. That is, each of the image forming units 10 (specifically, 10Y, 10M, 10C, and 10K) is driven in accordance with the digital image signal of a corresponding one of the colors. Next, the exposure unit 13 of each of the image forming units 10 radiates the laser beam Bm in accordance with the digital image signal so as to form an electrostatic latent image on the photosensitive drum 11 charged by the charging roller 12. The electrostatic latent images formed on the photosensitive drums 11 are developed by the developing units 14 so as to form the toner images of the respective colors. In the case where the image forming apparatus 1 is configured as a copier, a document set on a document table (not illustrated) is read by a scanner, and read signals having been obtained are converted into digital image signals by a processing circuit. Then, it is sufficient that toner images of the colors be formed similarly to the above description.

After that, the toner images formed on the photosensitive drums 11 are sequentially transferred onto the surface of the intermediate transfer belt 20 through first transfer by the first transfer rollers 15 at first transfer positions where the photosensitive drums 11 and the intermediate transfer belt 20 are in contact with one another. Toner remaining on each of the photosensitive drums 11 after the first transfer has been performed is removed by the drum cleaner 16.

The toner images having been transferred onto the intermediate transfer belt 20 through first transfer as described above are superposed on one another on the intermediate transfer belt 20 and transported to the second transfer position as the intermediate transfer belt 20 is rotated. Meanwhile, the sheet P is transported to the second transfer position at the predetermined timing and nipped between the second transfer roller 31 and the backup roller 24 that faces the second transfer roller 31.

The toner images held on the intermediate transfer belt 20 are transferred onto the sheet P through second transfer by operation of a transfer electric field formed between the second transfer roller 31 and the backup roller 24 at the second transfer position. The sheet P onto which the toner images have been transferred is transported to the fixing device 50 by the transport belt 43. The fixing device 50 applies heat and pressure to the toner images on the sheet P to fix the toner images. After that, the sheet P is fed to an output tray (not illustrated) provided outside the apparatus. Toner remaining on the intermediate transfer belt 20 after the second transfer has been performed is removed by the belt cleaner 26.

### Description of a Signal Processing System

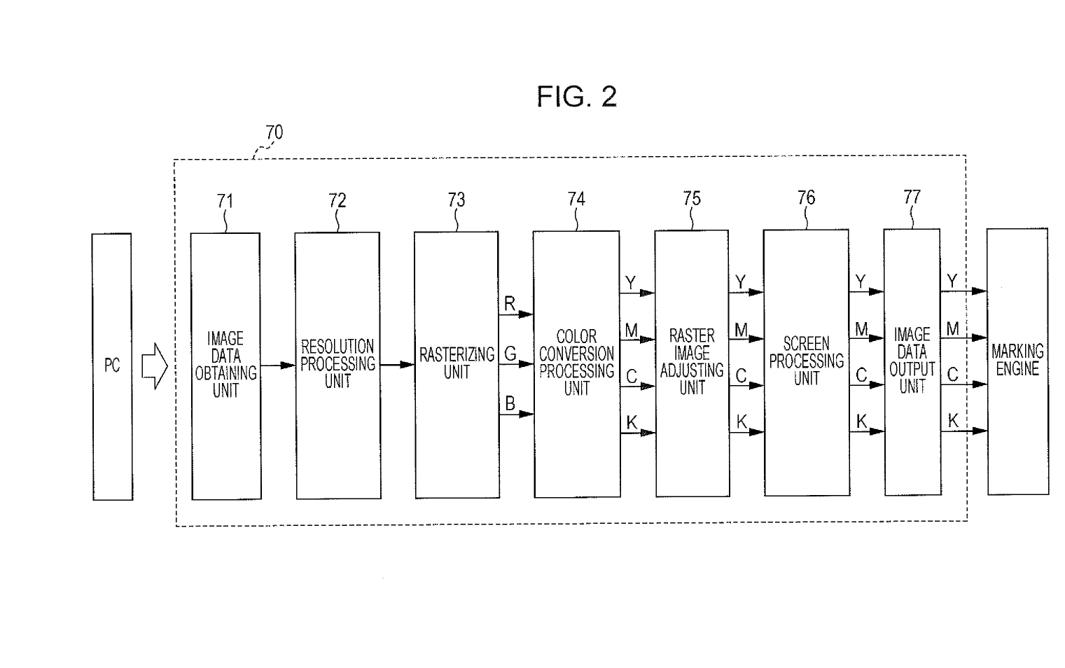

FIG. 2 is a block diagram illustrating a signal processing system of the controller 70 of the image forming apparatus 1.

FIG. 2 illustrates not only the signal processing system of the controller 70 but also a PC serving as an external device outside the image forming apparatus 1 and a marking engine that forms images in accordance with image signals processed by the signal processing system. The marking engine corresponds to, for example, the image forming section that actually forms images in the image forming apparatus 1 illustrated in FIG. 1. In the present example, the image forming apparatus 1 is configured as a printer. A flow of processing of the image signals is described below with reference to FIG. 2.

The controller 70 includes an image data obtaining unit 71, a resolution processing unit 72, a rasterizing unit 73, a color conversion processing unit 74, a raster image adjusting unit 75, a screen processing unit 76, and an image data output unit 77. The image data obtaining unit 71 serves as an example of an image information obtaining unit that obtains image data (image information) created for outputting an image by the image forming apparatus 1. The resolution processing unit 72 decides the resolutions of the image data and the marking engine. The rasterizing unit 73 performs rasterization in accordance with the resolution processed by the resolution processing unit 72 to create a raster image. The color conversion processing unit 74 converts red-green-blue (RGB) data to YMCK data. The raster image adjusting unit 75 adjusts a raster image converted by the color conversion processing unit 74. The screen processing unit 76 performs a screen process. The image data output unit 77 outputs the image data having undergone image processing.

According to the present exemplary embodiment, initially, the image data obtaining unit 71 receives image data from the external PC. This image data is printing data that a user of the PC wishes to print with the image forming apparatus 1.

When the resolutions of the marking engine and the image data are different from each other, the resolution processing unit 72 adjusts the resolutions of the marking engine and the image data. The details of processing of the resolution processing unit 72 will be described later.

The rasterizing unit 73 rasterizes the image data output from the resolution processing unit 72 such that the image data is converted into pixel-by-pixel raster data to obtain a raster image. The rasterizing unit 73 outputs the converted raster data as RGB video data. At this time, the rasterizing unit 73 outputs the RGB data on a page-by-page basis.

The color conversion processing unit 74 converts the RGB data input from the rasterizing unit 73 into a device independent color value such as [XYZ], [L*a*b*], or [L*u*v*]. The color value is then converted into and output as the YMCK data of the colors reproducible by the image forming apparatus 1 (colors of the toners as color materials: yellow (Y), magenta (M), cyan (C), and black (K)). The YMCK data includes Y-color data, M-color data, C-color data, and K-color data, which are separated from one another in accordance with the colors.

The raster image adjusting unit 75 performs a variety of adjustments by performing processes such as γ-conversion, a fineness process, and a half-tone process on the YMCK data input from the color conversion processing unit 74 so as to obtain further improved image quality with the image forming apparatus 1.

The screen processing unit 76 performs the screen process on the image information by a dither mask process using a dither mask in which predetermined thresholds are arrayed in the main scanning direction and the sub-scanning direction. Through this process, the image data is changed from, for example, multi-level image data to binary image data.

The image data output unit 77 outputs the image data on which the image processes including such as a color conversion process have been performed to the marking engine.

Images formed by the marking engine may include a barcode image.

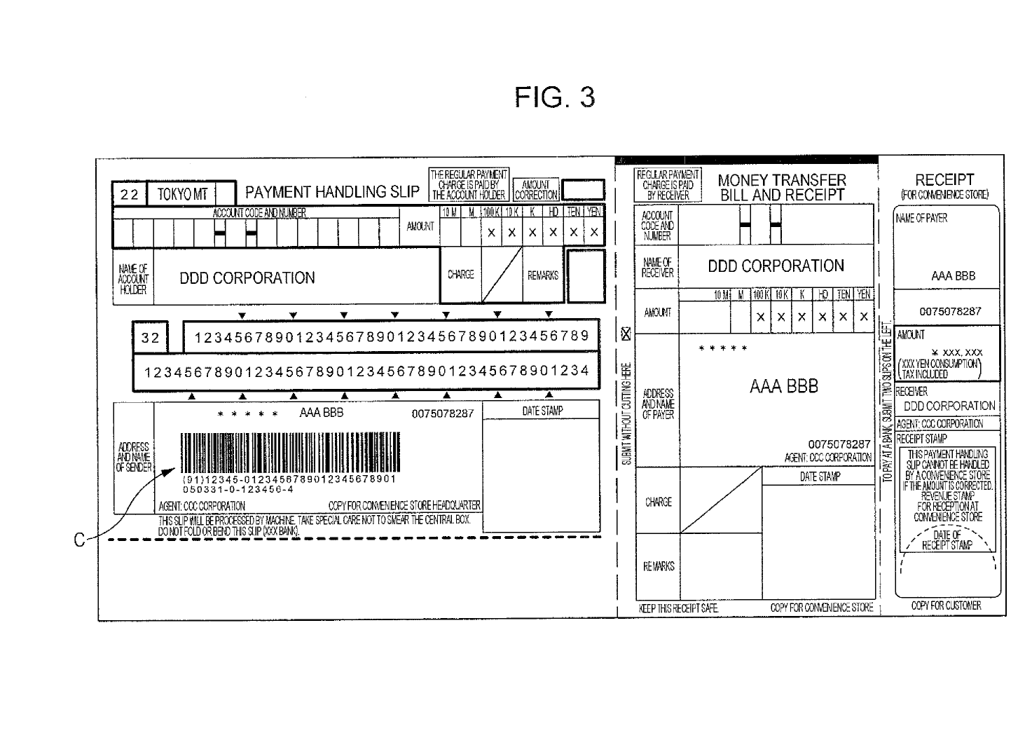

FIG. 3 illustrates an example of a barcode image.

In this example illustrated in FIG. 3, a barcode image C is formed in a slip. This barcode is a so-called one-dimensional barcode. A barcode includes various types of information such as, for example, a country code, a manufacturer code, product code information of a product, customer information, and a check digit.

In order to form such a barcode image, the number of dots (the number of pixels) of a module width may be specified at plural resolutions. In this case, the module width refers to a line width of a bar (module, black bar) included in a barcode.

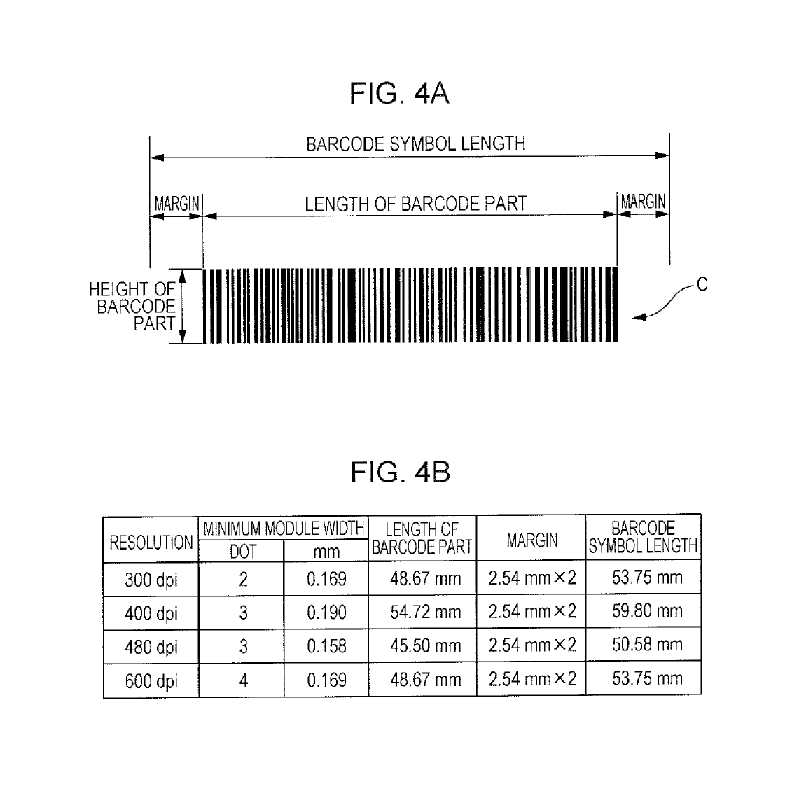

FIGS. 4A and 4B illustrate a guideline in accordance with GS1-128 regarding such a barcode image C. This guideline is applied to the case where, for example, a convenience store acts as an agency for receiving charges with a slip as illustrated in FIG. 3.

Here, the “minimum module width” refers to the width of the thinnest module out of the modules included in the barcode image C. The “length of the barcode part” refers to the length of the barcode image C in a direction perpendicular to each of the modules of the barcode image C, and specifically in FIG. 4A, refers to the horizontal width of the barcode image C. The “margin” refers to the length of margins set in the direction perpendicular to each of the modules with the barcode image C interposed therebetween, and specifically in FIG. 4A, the horizontal width of the margin set on each of the left and right of the barcode image C. The “barcode symbol length” refers to the sum of the horizontal length of the barcode image C and the lengths of the margins in the direction perpendicular to each of the modules, and specifically in FIG. 4A, refers to the sum of the length of the barcode part and the lengths of two margins.

As illustrated in FIG. 4B, the number of dots and the length as the minimum module width, the length of the barcode part, the margin, and the barcode symbol length are decided corresponding to each of the resolutions of the marking engine (in this case, the following four resolutions: 300 dots per inch (dpi), 400 dpi, 480 dpi, and 600 dpi). According to the guideline of GS1-128, the barcode symbol length is specified as 60 mm or less and the height of the barcode part is uniformly specified as 10 mm or more regardless of the resolution of the marking engine.

However, there may be a case where the resolution of the image data does not match the resolution of the marking engine. Examples of such a case include a case where the resolution of the image data is 400 dpi and the resolution of the marking engine is 600 dpi. Typically in this case, the resolution of the image data is converted so that the resolution of the image data matches the resolution of the marking engine in the related-art.

When the resolution of the image data is 400 dpi, the minimum module width is 3 dots according to the guideline of GS1-128 illustrated in FIG. 4B. Other module widths become multiples of 3 dots and are 6 dots, 9 dots, and 12 dots in this case. That is, there are the following four module widths: 3 dots, 6 dots, 9 dots, and 12 dots. Likewise, the widths of spaces (white bars) between the modules are set to be 3 dots, 6 dots, 9 dots, and 12 dots.

When the resolution of 400 dpi of the image data is converted into the resolution of 600 dpi of the marking engine, the numbers of dots are multiplied by 1.5 by simple calculations as follows: 3/6/9/12 dots to 4.5/9/13.5/18 dots.

It is noted that, in this case, 4.5 dots are converted into 4 dots or 5 dots and 13.5 dots are converted into 13 dots or 14 dots.

Thus, actually, 3/6/9/12 dots are converted into 4 or 5/9/13 or 14/18 dots.

When the resolutions are converted as described above, the numbers of dots that are originally the same as each other become different numbers of dots. In other words, a single number of dots are converted into any one of plural numbers of dots. This may be likely to occur when one of the resolution of the image data and the resolution of the marking engine is not an integer multiple of the other. Such variation in the number of dots after the conversion of the resolution may lead to the following problem.

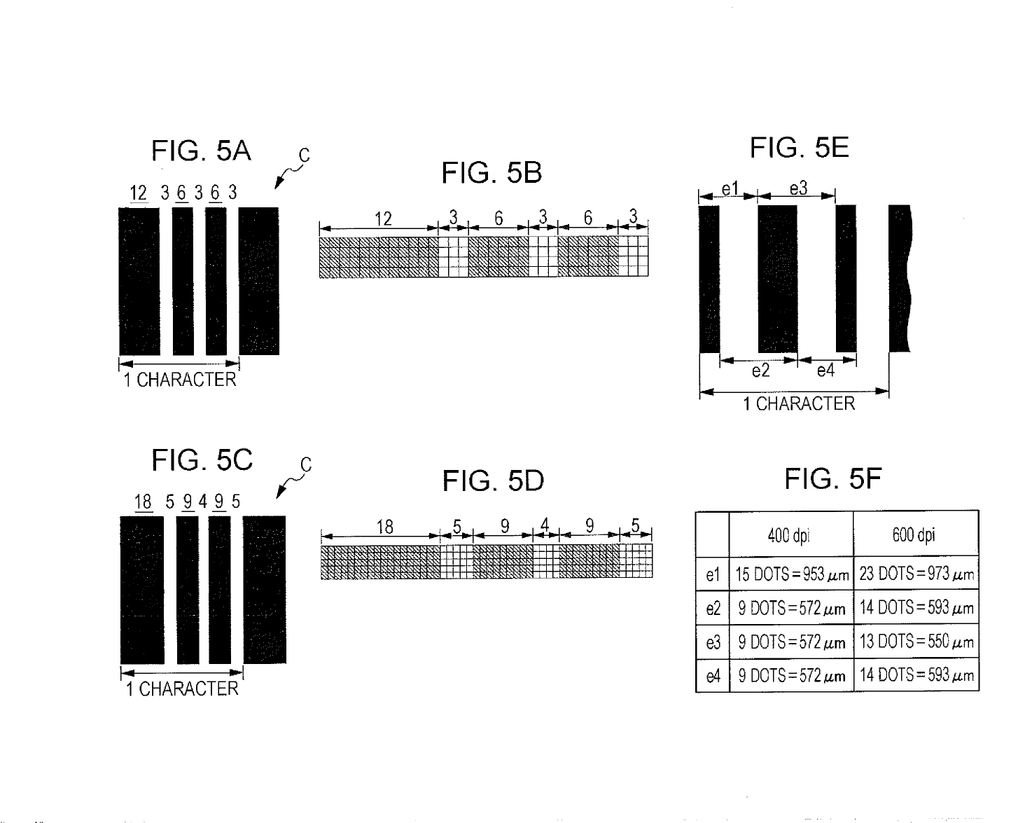

FIGS. 5A to 5F illustrate a problem that may occur when the numbers of dots that are the same before the resolutions are converted become different from one another after a resolution has been converted.

Out of FIGS. 5A to 5F, FIGS. 5A and 5B illustrate the widths of the modules and the white bars between the modules in the number of dots when the resolution is 400 dpi. The modules illustrated in FIG. 5A are used to represent a single character. FIG. 5B is an enlarged view of part of FIG. 5A. As illustrated in FIGS. 5A and 5B, the module widths are respectively 12 dots, 6 dots, and 6 dots, and the widths of the white bars between the modules are uniformly 3 dots. In FIGS. 5A to 5D, the numbers described above the barcode image C represent these numbers of dots.

FIGS. 5C and 5D illustrate the widths of the modules and the white bars between the modules in the number of dots when the resolution is converted from 400 dpi into 600 dpi. FIG. 5C illustrates the modules used to represent a single character. FIG. 5D is an enlarged view of part of FIG. 5C.

As illustrated in FIGS. 5C and 5D, when the resolution is converted from 400 dpi into 600 dpi, 6 dots are uniformly converted into 9 dots and 12 dots are uniformly converted into 18 dots. However, 3 dots at 400 dpi are converted into 4 dots or 5 dots when the resolution is converted into 600 dpi. FIGS. 5C and 5D illustrate a case where the widths of the white bars between the modules become different numbers of dots, that is, become 4 dots or 5 dots.

When reading the barcode, the single character is read by reading the widths of e1, e2, e3, and e4 illustrated in FIG. 5E.

FIG. 5F illustrates changes in the widths of e1 to e4 when the resolution is 400 dpi and the resolution is converted from 400 dpi into 600 dpi.

As illustrated in FIG. 5F, it is understood that, when the resolution is 400 dpi, the widths of e2, e3, and e4 are the same (9 dots, 572 μm). It is also understood that, when the resolution is converted into 600 dpi, however, the widths of e2 and e4 (14 dots, 593 μm) are different from the width of e3 (13 dots, 550 μm).

Barcode reading accuracy is decided by (i) the contrast ratio between the modules and the white bars between the modules, (ii) the total of the module widths, and (iii) the distances between edges of the modules illustrated in FIG. 5E. In this case, a problem relating to (iii) may occur and the barcode reading accuracy may be degraded.

Accordingly, the resolution processing unit 72 of the present exemplary embodiment is configured as follows so as to suppress the above-described problem.

### Description of the Resolution Processing Unit

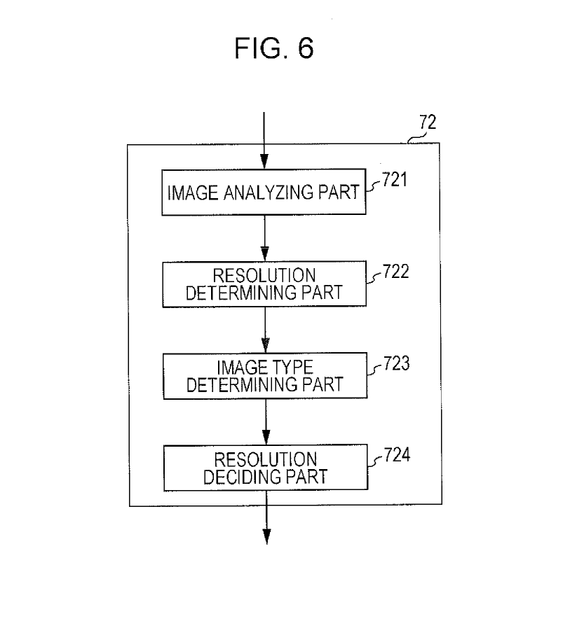

FIG. 6 is a block diagram illustrating the resolution processing unit 72 according to the present exemplary embodiment.

As illustrated in FIG. 6, the resolution processing unit 72 includes an image analyzing part 721, a resolution determining part 722, an image type determining part 723, and a resolution deciding part 724.

The image analyzing part 721 analyzes the image data obtained by the image data obtaining unit 71 (see FIG. 2), and analyzes whether or not a bitmap image is included.

Image data includes a bitmap image, a text image, and a graphic image. Typically, in the case of a bitmap image, tone value data of a predetermined number of bits (for example, 8 bits) is included. In the case of a text image, font data is included, and in the case of a graphic image, a rendering command is included. Thus, by analyzing these characteristics, whether or not a bitmap image is included in image data may be recognized.

The resolution determining part 722 determines the resolution of the image data when the image data includes a bitmap image. In many cases, the resolution of image data is included in a header or the like of the image data. Thus, the resolution determining part 722 refers to the header or the like to determine the resolution of the image data.

The image type determining part 723 determines whether or not the image data includes barcode image information. A method of determining whether or not the image data includes barcode image information will be described later.

The resolution deciding part 724 decides the resolution of the marking engine and the resolution of the image data. At this time, in the case where the image data includes the barcode image, the resolution deciding part 724 performs the following processes.

When the resolution or one of resolutions of the marking engine is an integer multiple of the resolution of the image data or the resolution of the image data is an integer multiple of the resolution or one of the resolutions of the marking engine, the resolution deciding part 724 selects such resolutions as the resolution of the marking engine and the resolution of the image data.

In contrast, when the resolution or the resolutions of the marking engine are not an integer multiple of the resolution of the image data and the resolution of the image data is not an integer multiple of the resolution or any of the resolutions of the marking engine, a different resolution is regarded as the resolution of the barcode image part of the image data so that the resolution of the barcode image part of the image data is an integer multiple of the resolution or one of the resolutions of the marking engine or the resolution or one of the resolutions of the marking engine is an integer multiple of the resolution of the barcode image part of the image data.

The resolution deciding part 724 outputs the image data at the decided resolution to the rasterizing unit 73. The rasterizing unit 73 performs rasterization in accordance with the decided resolution.

It is assumed that, for example, the marking engine is provided with two resolutions, that is, 600 dpi and 1200 dpi, and the resolution of the image data is 400 dpi. In this case, 1200 dpi is three times 400 dpi, and is an integer multiple of 400 dpi. In contrast, 600 dpi is 1.5 times 400 dpi and is not an integer multiple of 400 dpi. Thus, in this case, the resolution deciding part 724 selects 1200 dpi as the resolution of the marking engine. The resolution deciding part 724 selects 400 dpi as the resolution of the image data without a change.

In contrast, it is assumed that the marking engine is provided with two resolutions, that is, 600 dpi and 1200 dpi, and the resolution of the image data is 480 dpi. In this case, either the resolution of 600 dpi or the resolution of 1200 dpi of the marking engine is not an integer multiple of 480 dpi. Thus, in this case, the resolution deciding part 724 regards the resolution of the image data that is originally 480 dpi as 400 dpi. Thus, the resolution deciding part 724 selects 1200 dpi as the resolution of the marking engine and 400 dpi as the resolution of the image data.

As has been described, according to the present exemplary embodiment, the resolution of the marking engine is selected from among the resolutions usable for the marking engine and selected in accordance with the resolution of the image data so that one of the resolution of the marking engine and the resolution of the image data is an integer multiple of the other. At this time, a resolution to be regarded as the resolution of the image data, which is selected so that one of the resolution to be regarded as the resolution of the image data and the resolution of the marking engine is an integer multiple of the other, is selected as a value close to the resolution of the image data. Furthermore, the resolution to be regarded as the resolution of the image data, which is selected so that one of the resolution to be regarded as the resolution of the image data and the resolution of the marking engine is an integer multiple of the other, is selected as a resolution that is lower than the resolution of the image data.

In this case, the barcode image that is 480 dpi is regarded as 400 dpi in the rasterization. Thus, the image to be formed is larger than the original image. However, in this case, the resolution of the marking engine and the resolution of the image data is in the relationship in which one of the resolution of the marking engine and the resolution of the image data is an integer multiple of the other. Thus, the problem of the numbers of dots of the module widths and the white bars of the barcode image varying such that a single number of dots become any one of plural numbers of dots as described above does not necessarily occur. Thus, it may be unlikely that the barcode reading accuracy is degraded. It is noted that the size of the image changes only at the barcode image part. Regarding the size of part other than the barcode image part, resolution conversion is performed and the size of the image does not change.

### Description of Operation of the Resolution Processing Unit

Next, operations of the resolution processing unit 72 are described in more detail.

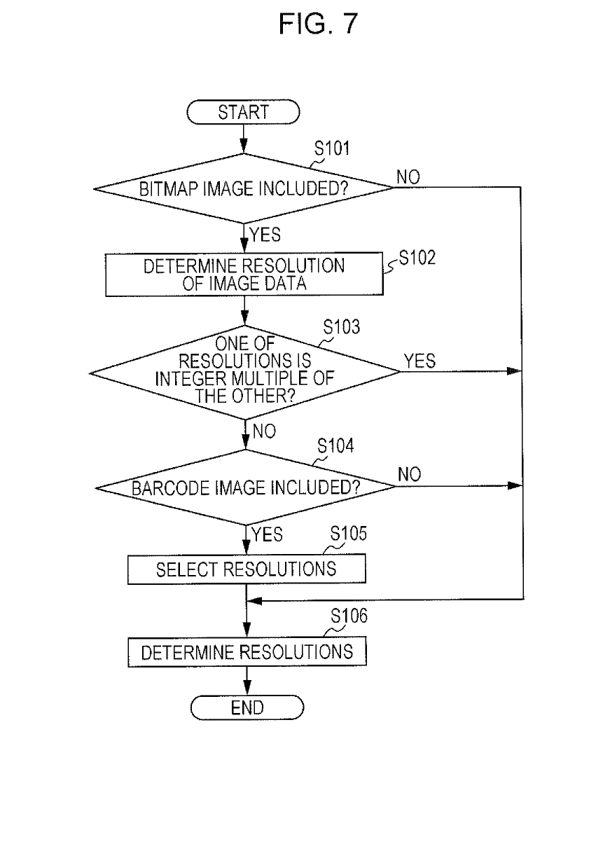

FIG. 7 is a flowchart illustrating the operations of the resolution processing unit 72.

The operations of the resolution processing unit 72 are described below with reference to FIGS. 6 and 7.

Initially, the image analyzing part 721 analyzes the image data obtained by the image data obtaining unit 71 (see FIG. 2), and analyzes whether or not a bitmap image is included (step S101). When a bitmap image is not included (NO in step S101), processing advances to step S106.

When a bitmap image is included (YES in step S101), the resolution determining part 722 determines the resolution of the image data (step S102). Then, the resolution determining part 722 compares the resolution or the resolutions of the marking engine with the determined resolution of the image data. Thus, the resolution determining part 722 determines whether or not the resolution or one of the resolutions of the marking engine is an integer multiple of the resolution of the image data or the resolution of the image data is an integer multiple of the resolution or one of the resolutions of the marking engine (step S103). If the resolution or one of the resolutions of the marking engine is an integer multiple of the resolution of the image data or the resolution of the image data is an integer multiple of the resolution or one of the resolutions of the marking engine (YES in step S103), the processing advances to step S106.

In contrast, if the resolution or the resolutions of the marking engine are not an integer multiple of resolution of the image data and the resolution of the image data is not an integer multiple of the resolution or any of the resolutions of the marking engine (NO in step S103), the image type determining part 723 determines whether or not the image data includes barcode image information (step S104). When the image data does not include barcode image information (NO in step S104), the processing advances to step S106.

Here, if the image data includes barcode image information (YES in step S104), the resolution is selected as follows (step S105).

That is, if the resolution or one of the resolutions of the marking engine is an integer multiple of the resolution of the image data or the resolution of the image data is an integer multiple of the resolution or one of the resolutions of the marking engine, the resolution deciding part 724 selects such resolutions as the resolution of the marking engine and the resolution of the image data. That is, in this case, the resolution of the image data is the resolution having been obtained by the image data obtaining unit 71 without a change.

In contrast, if the resolution or the resolutions of the marking engine are not an integer multiple of the resolution of the image data and the resolution of the image data is not an integer multiple of the resolution or any of the resolutions of the marking engine, as described above, the resolution deciding part 724 regards the resolution, of the barcode image part of the image data as a different resolution so that the resolution of the barcode image part of the image data is an integer multiple of the resolution or one of the resolutions of the marking engine or the resolution or one of the resolutions of the marking engine is an integer multiple of the resolution of the barcode image part of the image data.

Next, the resolution deciding part 724 decides the resolution of the marking engine and the resolution of the image data (step S106).

When the processing advances from step S105 to step S106, the resolution deciding part 724 performs decision with the resolution of the marking engine and the resolution of the image data having been selected in step S105.

In the case of NO in step S101, YES in step S103, or NO in step S104, the resolution deciding part 724 selects the resolution of the marking engine from among resolutions usable for the marking engine, and selects the resolution having been obtained by the image data obtaining unit 71 as the resolution of the image data without a change.

### Description of Operation of the Image Type Determining Part

Next, operations of the image type determining part 723 are described in more detail.

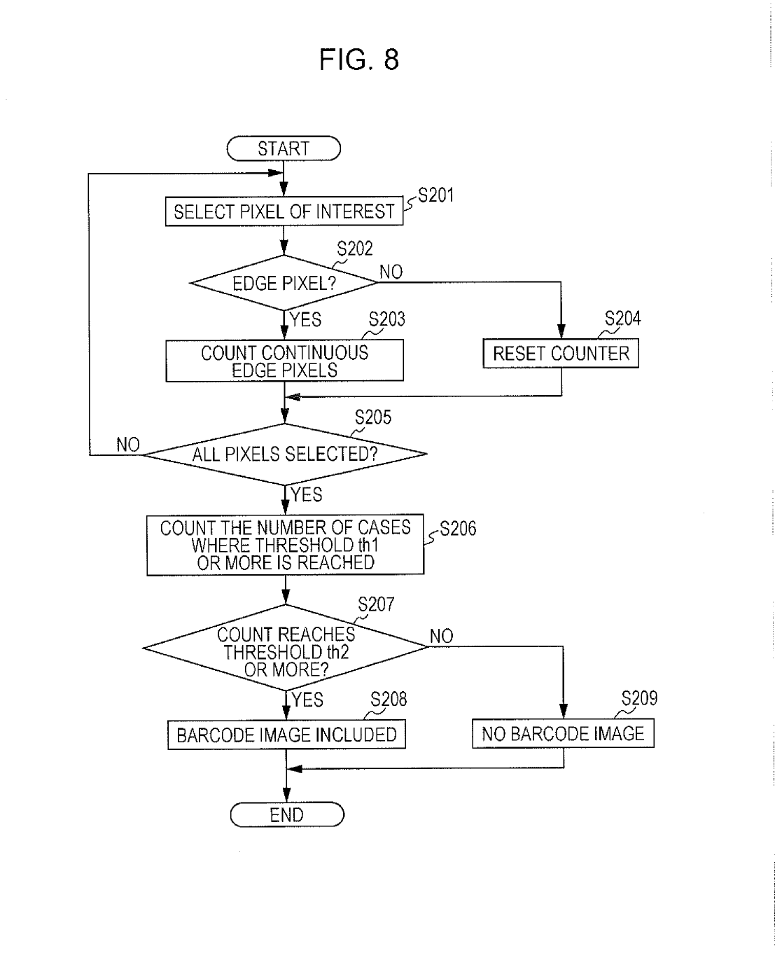

FIG. 8 is a flowchart illustrating a procedure in which the image type determining part 723 determines whether or not barcode image information is included in the image data.

The flowchart illustrated in FIG. 8 illustrates a process performed in step S104 illustrated in FIG. 7 in more detail.

If the image data includes the bitmap image, the image type determining part 723 of the present exemplary embodiment performs the following determination: that is, if the bitmap image includes equal to or more than a predetermined number of edges that extend in the main scanning direction or the sub-scanning direction and that have a length equal to or more than a predetermined length, the image type determining part 723 determines that the image data includes barcode image information.

Initially, the image type determining part 723 selects pixels for performing edge determination from the image data as pixels of interest (step S201). These pixels of interest are sequentially selected from a region that is determined to be the bitmap image as a result of the analysis performed by the image analyzing part 721.

Next, the image type determining part 723 determines whether each of the pixels of interest is included in an edge (edge pixel) or not (non-edge pixel) (step S202).

Whether the pixel of interest is an edge pixel or a non-edge pixel is determined as follows:

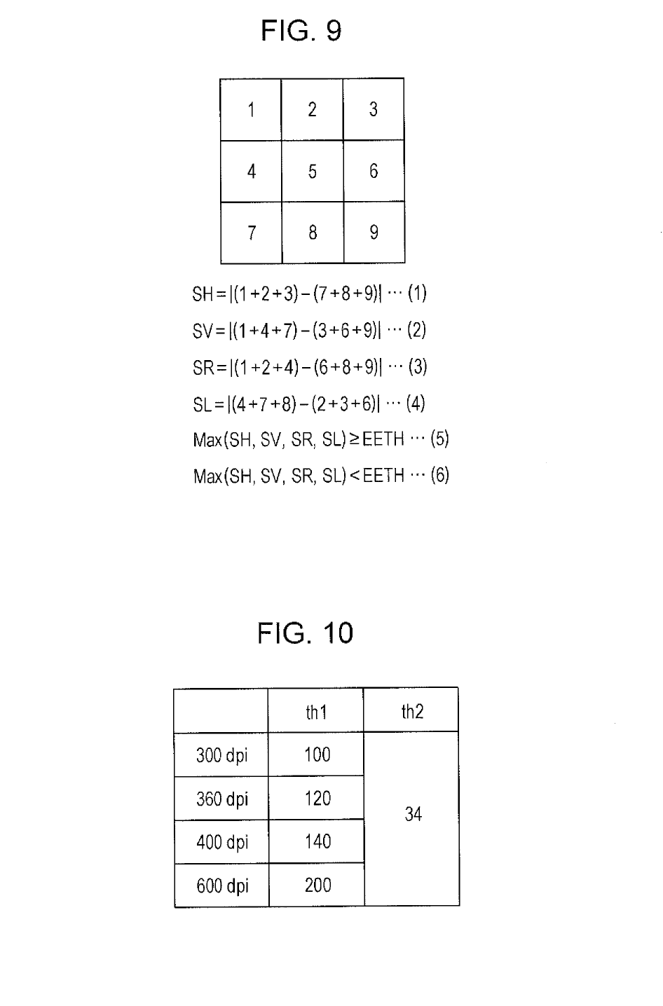

FIG. 9 illustrates a method of determining whether the pixel of interest is the edge pixel or the non-edge pixel.

In FIG. 9, a window is set in which dots are arranged three (vertical)-by-three (horizontal) array with the pixel of interest disposed at the center. Here, the central pixel denoted by “5” is the pixel of interest, and eight pixels adjacent to the pixel of interest are denoted by “1” to “4” and “6” to “9” as illustrated in FIG. 9. The values of SH, SV, SR, and SL are calculated by expressions (1) to (4) illustrated in FIG. 9. It is noted that the numerals 1 to 9 in expressions (1) to (4) are pixel values of the pixels denoted by “1” to “9” in FIG. 9. The pixel values are each, for example, an integer from 0 to 255 represented by an 8-bit value. Since the barcode is typically black, these pixel values may be the pixel value of K color data.

If a maximum value among the SH, SV, SR, and SL is equal to or more than a predetermined threshold EETH as represented by expression (5), the pixel of interest denoted by “5” is the edge pixel. In contrast, if the maximum value among the SH, SV, SR, and SL is less than the predetermined threshold EETH as represented by expression (6), the pixel of interest denoted by “5” is the non-edge pixel.

That is, when the pixel of interest denoted by “5” is the edge pixel, the pixel values of the pixels on both sides of the pixel of interest are largely different. In contrast, when the pixel of interest denoted by “5” is the non-edge pixel, pixel values of the pixels on both sides of the pixel of interest are not largely different. SH, SV, SR, and SL are calculated as the differences between the pixel values of the pixels on both sides of the pixel of interest denoted by “5”. Thus, whether the pixel of interest denoted by “5” is the edge pixel or the non-edge pixel is determined by whether the differences are equal to or more than the threshold EETH or less than the threshold SETH.

Referring back to FIG. 8, if the pixel of interest is the edge pixel (YES in step S202) and the edge pixels are continuously disposed in the horizontal (X direction, main scanning direction) and the vertical direction (Y direction, sub-scanning direction), the image type determining part 723 counts the number of edge pixels (step S203).

When the pixel of interest is the non-edge pixel (NO in step S202), the image type determining part 723 saves a count of the edge pixels by that time and resets the count (step S204).

The image type determining part 723 determines whether or not all the pixels have been selected in the region determined as the bitmap image (step S205).

If there still is a pixel that has not been selected (NO in step S205), the processing returns to step S201, so that a new pixel of interest is selected and whether this pixel of interest is included in the edge or the non-edge pixel is determined.

If all the pixels have been selected (YES in step S205), the image type determining part 723 counts the number of counts that reach a predetermined threshold th1 out of the counts saved in step S204. This counting is performed in the horizontal and the vertical directions of the image (step S206).

The image type determining part 723 determines whether or not the number of counts that reach the threshold th1 is equal to or more than a predetermined threshold th2 in each of the horizontal and vertical directions of the image (step S207).

If the number of counts that reach the threshold th1 is equal to or more than the predetermined threshold th2 (YES in step S207), the image type determining part 723 determines that barcode image information is included in the image data (step S208). In contrast, if this number of counts is less than the threshold th2 (NO in step S207), the image type determining part 723 determines that barcode image information is not included in the image data (step S209).

Here, the image type determining part 723 counts the number of edges having lengths that are more than a predetermined length in each of the horizontal and vertical directions of the image. That is, the numbers of the pixels of interest determined as the edges continuous in the horizontal and vertical directions of the image are calculated. This process is performed in steps S203 to S204 described above. If a count of edge pixels become equal to or more than the threshold th1, it is determined that there is an edge having a length equal to or more than a predetermined length. Furthermore, the number of counts having been determined as the edges (the number of edges) is counted, so that how many edges that have a length equal to or more than the predetermined length exist is determined. This process is performed in step S206 described above. Furthermore, if this number of edges becomes equal to or more than the predetermined threshold th2, it is determined that a barcode image is included.

The reason why the counting is performed in the horizontal and vertical directions of the image is that the barcode image is typically formed in the horizontal or vertical direction. When the barcode image is formed in the horizontal direction, the modules are lines in the vertical direction. Thus, the pixels of interest determined as the edges are continuous in the vertical direction. When the barcode image is formed in the vertical direction, the modules are lines in the horizontal direction. Thus, the pixels of interest determined as the edges are continuous in the horizontal direction.

In the present exemplary embodiment, the predetermined length of each of the edges is, for example, equal to or more than 9 mm. The number of the pixels corresponding to a length of the edge of 9 mm varies depending on the resolution of the image data. Thus, the threshold th1 corresponding to the length of the edge of 9 mm is predetermined. The threshold th2 does not vary depending on the resolution of the image data.

FIG. 10 is a table illustrating examples of the threshold th1 and threshold th2.

As illustrated in FIG. 10, the threshold th1 varies depending on the resolution of the image data, and increases as the resolution of the image data is increased. The reason for this is that, as the resolution is increased, more pixels are required for the predetermined length of the edge.

Furthermore, the threshold th2 is set to 34 here. In other words, this threshold is set for the case where the number of modules included in the barcode is 17.

The controller 70 of the present exemplary embodiment may be understood as an image processing device (image processing section) which, when the image data for forming an image with a marking engine that forms the image on the sheet P includes the barcode image information and one of the resolution of the marking engine and the resolution of the image data is not an integer multiple of the other, regards the resolution of the barcode image part of the image data as a different resolution to perform rasterization so that the resolution of the barcode image part of the image data and the resolution of the marking engine is an integer multiple of the other.

Although the image forming apparatus 1 that uses the electrophotographic method has been described in the above-described example, the image forming apparatus 1 is not limited to this. For example, the above-described example may be applied to an ink-jet image forming apparatus.

Although the so-called one-dimensional barcode has been described in the above-described example, the barcode is not limited to this. For example, the above-described example may be applied to a two-dimensional barcode such as QR code (registered trademark). In the case of, for example, the QR code, the number of dots of minimum unit cells (modules) included in a symbol of a QR code may vary in the horizontal and vertical directions when the resolution is converted. However, by applying the above-described configuration, variation of the numbers of dots of the modules and the spaces between the modules in the horizontal and vertical directions may be suppressed.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
an image forming section that forms an image on a recording medium; and
an image processing section that, when image information for forming the image with the image forming section includes information of a barcode image and one of a resolution of the image forming section and a resolution of the image information is not an integer multiple of the other, regards a resolution of a part of the image information used for the barcode image as a different resolution so that one of the resolution of the part of the image information used for the barcode image and the resolution of the image forming section is an integer multiple of the other to perform rasterization.

2. The image forming apparatus according to claim 1,
wherein the image processing section selects the resolution of the image forming section from among resolutions usable for the image forming section, and the image processing section selects the resolution of the image forming section in accordance with the resolution of the image information so that one of the resolution of the image forming section and the resolution of the image information is an integer multiple of the other.

3. The image forming apparatus according to claim 1,
wherein, when the image information includes a bitmap image and the bitmap image includes equal to or more than a predetermined number of edges that extend in a main scanning direction or a sub-scanning direction and that have a length or lengths equal to or more than a predetermined length, the image processing section determines that the image information includes the information of the barcode image.

4. The image forming apparatus according to claim 2,
wherein, when the image processing section regards the resolution of the part of the image information used for the barcode image as the different resolution so that one of the resolution of the part of the image information used for the barcode image and the resolution of the image forming section is an integer multiple of the other, the image processing section selects the different resolution so that the different resolution is lower than the resolution of the image information, thereby increasing a size of the barcode image formed by the image forming section.

5. An image processing device comprising:
a resolution processing unit that, when image information for forming an image with an image forming section, which forms the image on a recording medium, includes information of a barcode image and one of a resolution of the image forming section and a resolution of the image information is not an integer multiple of the other, regards a resolution of a part of the image information used for the barcode image as a different resolution so that one of the resolution of the part of the image information used for the barcode image and the resolution of the image forming section is an integer multiple of the other; and
a rasterizing unit that performs rasterization in accordance with the resolutions processed by the resolution processing unit.
